(19) United States
(12) Patent Application Publication
(10) Pub. No.: US 2009/0171841 A1
(43) Pub. Date: Jul. 2, 2009

(54) METHOD AND SYSTEM FOR TRANSFERRING FUNDS BETWEEN ACCOUNT HOLDERS

(75) Inventor: Simon Blythe, Ely (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/966,323

(22) Filed: Dec. 28, 2007

(51) Int. Cl. G06Q 40/00

(52) U.S. Cl. 705/41; 705/39; 705/44

(57) ABSTRACT

The preferred embodiments are directed to facilitating a transfer of funds between account holders. The preferred embodiments can receive account information from a transaction devices associated with a first account and a second account and can receive a specified amount of funds to be transferred to the second account. The preferred embodiments can transfer the specified amount of funds from the first account to the second account in response to receiving the account information from the transaction devices of associated with the first and second accounts and the specified amount of funds.

### BACKGROUND

In recent years, non-cash transactions have become a preferred method of payment for consumers. For example, consumers who are account holders can enter into transactions using transaction devices associated with their account, such as credit cards or debit cards. Credit cards typically allow account holders to engage in financial transactions with a participating merchant without a present requirement of money from the account holder. In a typical credit card transaction, the participating merchant receives payment from a financial institution that has agreed to allow the account holder to make purchases on credit with the promise to pay the financial institution the purchase amount plus some calculated interest at a later time. Debit cards function in a similar manner as credit cards, but instead of drawing on credit, the account holder draws against money deposited with a financial institution, usually a financial institution with which the account holder has a bank account.

Despite the wide use of these conventional accounts and transaction devices, they do not typically allow transfer of funds from one account holder to another account holder using the transaction devices associated with each account holder. In other words, if an account holder wishes to transfer one hundred dollars to another account holder, the user must write the other account holder a check, withdraw cash from/against the account and give it to the other account holder, or use other conventional methods.

A system and method for transferring funds between account holders is desired that allows for easy and efficient transfer of funds.

### SUMMARY

The preferred embodiments of the present invention facilitate transfer of funds between two or more accounts using transaction devices associated with the accounts. When one account holder wishes to transfer account information to another account holder, the account holders, the user terminal accesses the account holders' account information from the transaction devices. The account holder who wishes to transfer funds to the other account holder can enter a specified amount funds to be transferred and the user terminal can transfer funds from one account to the other. The preferred embodiments of the present allow account holder to easily and efficiently transfer funds to another account holder.

In preferred embodiments, a method, system, and computer readable medium for facilitating a transfer funds between account holders are disclosed. The preferred embodiments receive account information from a transaction device associated with a first account, receive account information, such as an account number, from a transaction device associated with a second account, and receive a specified amount of funds to be transferred to a second account. The transaction devices can be smart cards, credit cards, debit cards, or the like. The preferred embodiments transfer the specified amount of funds from the first account to the second account in response to receiving the account information from the transaction devices of associated with the first and second accounts and the specified amount of funds. In some embodiments, the transferring can be performed by a user terminal and/or a financial terminal.

In some embodiments, the account information from the transaction devices associated with the first and second accounts can be verified for authorization before transferring funds. The verification can include receiving a pin number associated with at least one of the transaction device associated with the first account or the transaction device associated with the second account. To verify the account information, the account information can be sent to a financial terminal for verification from a user terminal. In other embodiments, the user terminal can perform the verification.

The preferred embodiments of the present invention, as well as other objects, features and advantages of the present invention will be apparent from the following detailed description, which is to be read in conjunction with the accompanying drawings. The scope of the invention will be pointed out in the claims

### BRIEF DESCRIPTION OF THE DRAWINGS

FIG. 1 depicts an exemplary financial transaction system in accordance with preferred embodiments of the present invention;

FIG. 2 is a flowchart that illustrates a transfer of funds between account holders in accordance with a preferred embodiment of the present invention.

### DETAILED DESCRIPTION OF PREFERRED EMBODIMENTS

The preferred embodiments are directed to facilitating transfer of funds between two or more accounts using transaction devices associated with the accounts. Account holders can use a user terminal that can access account information from transaction devices associated with accounts held by the account holders. When one account holder wishes to transfer account information to another account holder, the account holders allow the user terminal to access their account information, in some embodiment upon proper authorization by the account holder. The account holder who wishes to transfer funds to the other account holder can enter a specified amount funds to be transferred and the user terminal can transfer funds from one account to the other.

The preferred embodiments of the present allow account holder to easily and efficiently transfer funds to another account holder. In one example, the preferred embodiments of the present invention can be used to allow an account holder to tip another account holder. For example, the account holder may wish to tip a valet attendant for providing a valet service. A user terminal may be located at the valet station and the account holder may allow the user terminal to access account information from a transaction device associated with the account holder and the account holder's account. The account holder can enter a specified tip to give to the valet attendant. The valet attendant may then allow the user terminal to access the valet attendants account information and the user terminal can subsequently transfer the tip to the account of the valet attendant.

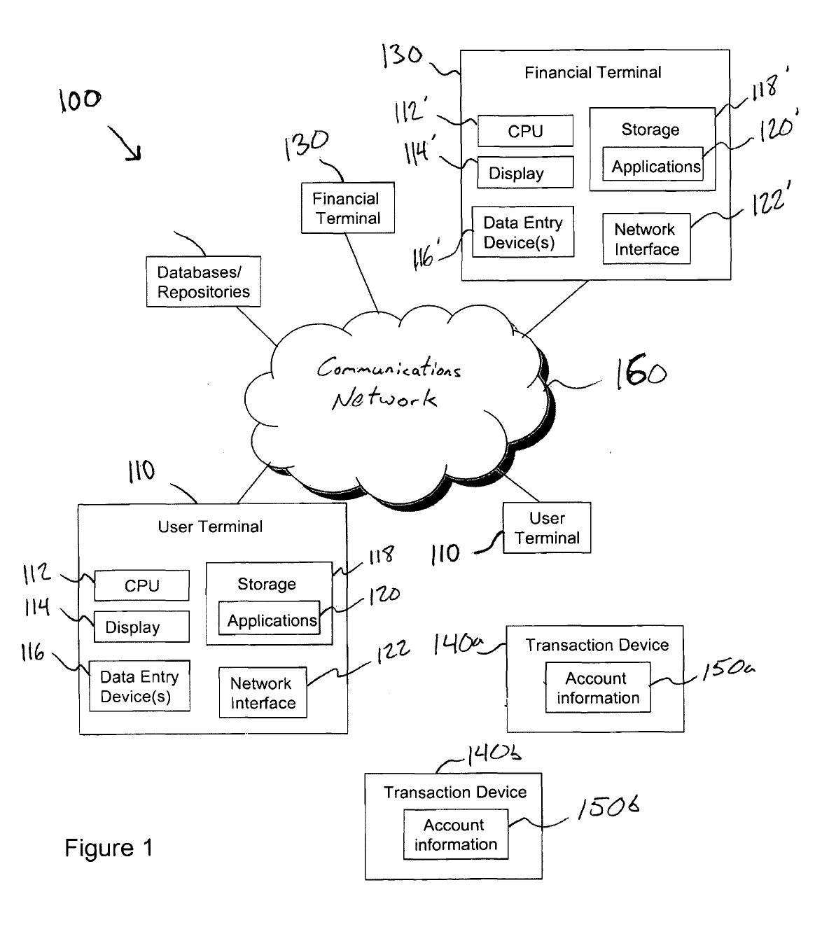

FIG. 1 depicts a financial transaction system 100 that preferably includes user terminals 110 associated with one or more financial institutions, one or more financial terminals 130, transaction devices 140a-b, databases/repositories 155 (hereinafter “database 155”), and communication network 160, such as a public switched telephone network (PSTN), virtual private network (VPN), Internet, or the like. The user terminals 110 can represent devices that read account information from transaction devices associated with account holders. Account holders can use the user terminals 110, for example, to facilitate transfers of funds between the account holders. The user terminals 110 can be dispersed throughout the world.

The user terminals 110 can receive, collect, and maintain information associated with account holders. In a preferred embodiment, the user terminals 110 are computing devices that are capable of reading information from transaction devices to facilitate transfer of funds between two or more transaction devices. The user terminals 110 can be a mainframe, personal computer (PC), laptop computer, workstation, handheld device, such as a PDA, or the like. In some embodiments, the user terminals 110 can be automated teller machines (ATMs) enhanced to facilitate such transfers.

In the illustrated embodiment, the user terminals 110 includes a central processing unit (CPU) 112 and preferably a display device 114. The display device 114 enables the user terminals 110 to communicate directly with user (i.e. account holders) through a visual display. The user terminal 110 can further include data entry device(s) 116, such as a keyboard, touch screen, infrared sensor, magnetic sensor, bar code reader, and/or mouse and can include storage 118 for storing data, such as transaction information, account information, and instructions, such as instructions for facilitating transfers of funds between accounts. The storage 118 can include such technologies as a floppy drive, hard drive, tape drive, Flash drive, optical drive, read only memory (ROM), random access memory (RAM), and the like.

Applications 120, such an application for facilitating fund transfers between account holders, described in more detail below, can be resident in the storage 118. The storage 118 can be local or remote to the user terminal 110. The applications 120 can generate a graphical user interface (GUI) that is depicted on the display 114 that allows account holders to interact with the user terminal 110. The GUI can, for example, allow users to enter a pin number (e.g., a code or password) associated with the transaction device to verify the transaction device against store account information and can allow an account holder to enter a type of transaction they wish to perform (e.g., fund transfer, deposit, withdrawal, etc.). For example, the entry device can be a keypad that allows a user to enter the pin number as well as a selected amount of funds to be transferred.

The user terminal 110 preferably includes a network interface 122 for communicating with other networked devices over the communications network 160. The CPU 112 operates to run the applications 120 in storage 118 by performing instructions therein and storing data resulting from the performed instructions, which may be depicted via the display 114 or by other mechanisms known to those skilled in the art, such as a printer.

Information can be read from transaction devices 140a-b and/or entered by account holders via one or more data entry devices 116. For example, the data entry device 116 can be a magnetic sensor for reading information from the transaction device. The financial institutions associated with the user terminals 110 can use this information when determining whether to authorize transfers, deposits, and/or withdrawals of funds.

The one or more financial terminals 130 can communicate with the user terminals 110 via the communication network 160. Information read from transaction devices 140a-b can be sent to the financial terminal 130, which can use the information when determining whether to authorize a transaction. To authorize the transaction, the financial terminal 130 can verify the information read for the transaction devices 140 against information stored by a financial institution in the financial terminal 130 or remote to the financial terminal 130. The financial terminal 130 can also store transaction information, which can include a transaction date and time, account holder names, and a user terminal location at which the transaction occurred (including street number, address, city, state, country, or the like).

The financial terminal 130 are preferably a computing device that includes like components as those of the user terminal 110. The financial terminal 130 can facilitate transfer of funds between two or more accounts associated with transaction devices using the account information and can include a CPU 112′, display device 114′, data entry device(s) 116′, storage 118′ for storing data, such as transaction information, account information, and applications 120′ including instructions, such as instructions for facilitating transfers of funds between accounts. In one embodiment, the user terminal 110 can collect and send the account information, which can include an account number, pin number (e.g., code or password), specified amount of funds to transfer, or the like, to the financial terminal 130. The financial terminal 130 can perform the verification and transferring of funds between accounts and may use one or more databases 155 for storing the account information or resulting transaction information.

The transaction devices 140a-b can be, but are not limited to a credit card, debit card, smart card, cellular phone or other suitable computing devices and preferably includes an account information 150a-b, respectively, associating the transaction device with an account. The account information can include an account number, the account holder's name, the account holder's address, and the like. The preferred embodiments of the transaction devices 140a-b are preferably implemented as a smart card or the like, that is capable of storing and allowing access to the account information 150a-b. Alternatively, the account information 150a-b can be embedded in magnetic strips of, for example, a credit card or debit card.

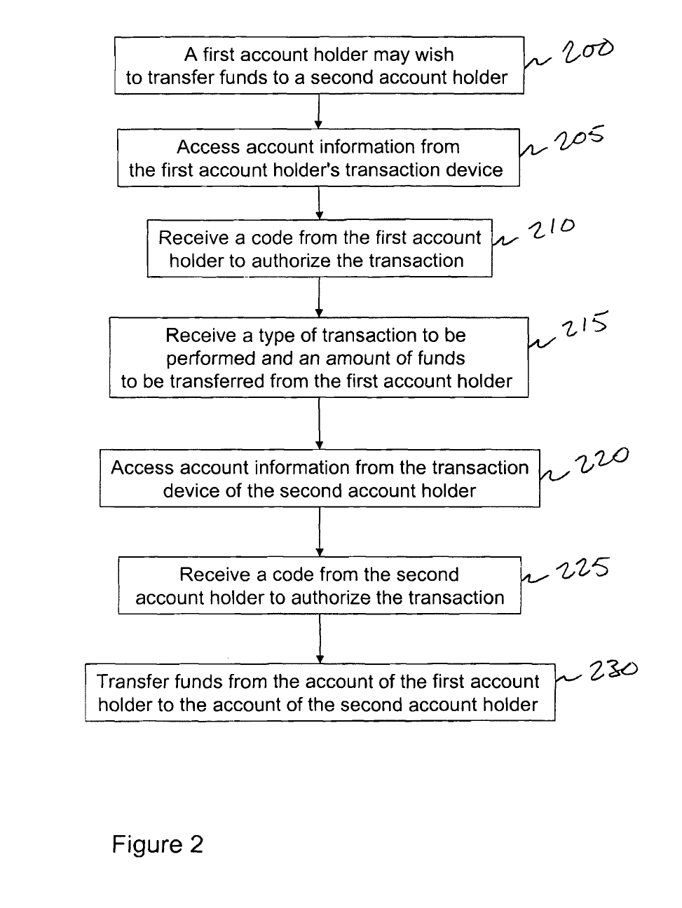

FIG. 2 is a flowchart that illustrates a transfer of funds between account holders in accordance with a preferred embodiment of the present invention. A first account holder may wish to transfer funds to a second account holder (step 200). The first and second account holders can use a user terminal to facilitate the transfer. A user terminal can access the account information from the first account holder's transaction device via a data entry device, such as a magnetic sensor, associated with the user terminal (step 205). The account holder can also enter a code via another data entry device, such as a key pad, to authorize the transactions (step 210). The first account holder specifies the type of transaction to be performed and enters an amount of funds to be transferred to the account associated with the second account holder (step 215). Subsequently, the user terminal accesses the account information from the transaction device of the second account holder (step 220). The second account holder can also enter a code via a data entry device to authorize the transaction (step 225). Upon authorization, the user terminal can transfer funds from the account of the first account holder to the account of the second account holder (step 230).

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method of transferring funds between account holders comprising:
receiving first account information being read from a first transaction device associated with a first account, the first account information including information concerning the first account;
receiving second account information being read from a second transaction device associated with a second account, the second account information including information concerning the second account;
receiving a specified amount of funds to be transferred to the second account from the first account; and
transferring the specified amount of funds from the first account to the second account in response to receiving the first account information from the first transaction device associated with first account, receiving the second account information from the second transaction device associated with the second account, and receiving the specified amount of funds to be transferred.

2. The method of claim 1, further comprising verifying the account information from the first and second transaction devices to authorize a transfer of funds.

3. The method of claim 2, wherein verifying the account information comprises receiving a pin number associated with at least one of the first and second transaction devices.

4. The method of claim 1, wherein receiving account information being read from the first transaction device associated with the first account comprises receiving an account number.

5. The method of claim 1, wherein the first transaction device associated with the first account comprises a smart card.

6. The method of claim 1, wherein the account information is received by a user terminal and the method further comprises sending the account information to a financial terminal for verification.

7. The method of claim 6, wherein transferring the specified amount of funds is performed by the financial terminal.

8. A computer readable medium comprising instructions executable by a computing device to perform a transfer of funds between account holders that, when applied to the computing device, cause the device to:
transfer a specified amount of funds from a first account to a second account in response to receiving first account information being read from a first transaction device of associated with the first account, the first account information including information concerning the first account, receiving second account information being read from a second transaction device associated with the second account, the second account information including information concerning the second account, and receiving a specified amount of funds to be transferred to a second account holder.

9. The medium of claim 8, further comprising instructions executable by a computing device to perform a transfer of funds between account holders that, when applied to the computing device, cause the device to verify the account information from the first and second transaction devices to authorize a transfer of funds.

10. The medium of claim 9, further comprising instructions executable by a computing device to perform a transfer of funds between account holders that, when applied to the computing device, cause the device to verify the account information using a pin number associated with at least one of the first and second transaction devices.

11. The medium of claim 8, further comprising instructions executable by a computing device that, when applied to the computing device, cause the device to perform a transfer of funds between account holders in response to receiving an account number associated with the first account and receiving account information associated with the second account.

12. A system for facilitating a transfer of funds between account holders comprising:
a computing system including at least one computing device, the computing system configured to:
receive first account information being read from a first transaction device associated with a first account, the first account information including information concerning the first account;
receive second account information being read from a second transaction device associated with a second account, the second account information including information concerning the second account;
receive a specified amount of funds to be transferred to the second account; and
transfer the specified amount of funds from the first account to the second account in response to receiving the first account information being read from the first transaction device associated with the first account, receiving the second account information being read from the second transaction device, and receiving the specified amount of funds.

13. The system of claim 12, wherein the computing system comprises a data entry device for accessing information from the first transaction device associated with the first account and the second transaction device associated with the second account.

14. The system of claim 12, wherein the at least one computing device is a user terminal.

15. The system of claim 12, wherein the at least one computing device is a financial terminal and the system further comprises a user terminal configured to access the account information from the transaction devices associated with the first and second accounts, the user terminal configured to (1) send the account information from the first transaction device associated with the first account, (2) send the account information from the second transaction device associated with the second account, and (3) send the specified amount of funds to be transferred to the second account to the financial terminal.

16. The system of claim 12, wherein the at least one computing device is configured to verify the account information in response to receiving a pin number associated with at least one of the first and second transaction devices.
